(19) United States
(12) Patent Application Publication
(10) Pub. No.: US 2012/0162775 A1
(43) Pub. Date: Jun. 28, 2012

(54) Method for Correcting Hyperstereoscopy and Associated Helmet Viewing System

(75) Inventors: Jean-Michel FRANCOIS, Cadaujac (FR); Sébastien ELLERO, Francescas (FR); Matthieu GROSSETETE, Bordeaux (FR); Joël BAUDOU, St Medard en Jalles (FR)

(73) Assignee: THALES, Neuilly-sur-Seine (FR)

(21) Appl. No.: 13/331,399

(22) Filed: Dec. 20, 2011

(30) Foreign Application Priority Data
Dec. 23, 2010 (FR) 10 05074

(51) Int. Cl. G02B 27/01

(52) U.S. Cl. 359/630

(57) ABSTRACT

The general field of the invention relates to binocular helmet viewing devices worn by aircraft pilots. In night use, one of the drawbacks of this type of device is that the significant distance separating the two sensors introduces hyperstereoscopy on the images restored to the pilot. The method according to the invention is a scheme for removing this hyperstereoscopy in the images presented to the pilot by graphical processing of the binocular images. Comparison of the two images makes it possible to determine the various elements present in the image, to deduce therefrom their distances from the aircraft and then to displace them in the image so as to restore images without hyperstereoscopic effects.

### CROSS-REFERENCE TO RELATED APPLICATION

This application claims priority to foreign French patent application No. FR 1005074, filed on Dec. 23, 2010, the disclosure of which is incorporated by reference in its entirety.

### FIELD OF THE INVENTION

The field of the invention is that of helmet viewers comprising low light level viewing devices used in aircraft cockpits. The invention applies most particularly to helicopters used for night missions.

### BACKGROUND

A night viewing system necessarily comprises low light level sensors or cameras and a helmet display worn by the pilot on his head which displays, superimposed on the exterior landscape, the images arising from these sensors. These systems are generally binocular so as to afford the maximum of visual comfort. In a certain number of applications, the low light level sensors are integrated into the helmet, thereby considerably simplifying the system while best reducing the parallax effects introduced by the difference in positioning between the sensors and the eyes of the pilot.

A viewing system of this type is represented in FIG. 1 in a functional situation worn by a pilot on his head. FIG. 1 is a top view. It comprises in a schematic manner the head of the pilot P and his viewing helmet C. The head P comprises two circles Y representative of the position of the eyes. The shell of the helmet comprises two sensors C_{BNL} termed BNLs, the acronym standing for “Low Light Level” (Bas Niveau de Lumière in French) making it possible to produce an intensified image of the exterior landscape. These sensors are disposed on each side of the helmet, as seen in FIG. 1. With each sensor is associated a helmet display HMD, the acronym standing for “Helmet Mounted Display”. The two helmet displays give two images at infinity of the intensified images. These two collimated images are perceived by the pilot's eyes. These two images have unit magnification so as to be best superimposed on the exterior landscape.

It is known that the picture capture used to obtain a natural representation of a 3D scene requires that an optimal distance be complied with between the left image capture and the right image capture. This distance corresponds to the mean separation of the left and right eyes termed the inter-pupillary distance or DIP and which equals about 65 millimetres in an adult human. If this distance is not complied with, the 3D representation is falsified. In the case of an overseparation, one speaks of hyperstereoscopy. The vision through such a so-called hyperstereoscopic system gives a significant under-evaluation of close distances.

3D filming systems are being developed in particular for cinema or else for virtual reality systems. Certain constraints may lead to system architectures where the natural separation of the eyes is not complied with between the two cameras when, for example, the size of the cameras is too big.

In the case of a helmet viewing system such as represented in FIG. 1 where, as was stated, the sensors BNL are integrated into the helmet, the natural separation DIP is difficult to comply with if it is desired to culminate in optimal integration of the system in terms of simplicity of production, weight and volume. Such systems, like the TopOwl® system from the company Thales or the MIDASH standing for “Modular Integrated Display And Sight Helmet” system from the company Elbit, then exhibit a very big overseparation D which is 4 to 5 times bigger than the natural separation of the eyes.

This hyperstereoscopy is compensated for by training the pilots who acclimatize to this effect and reconstruct their evaluations of the horizontal and vertical distances. Nonetheless, this hyperstereoscopy is perceived as troublesome by users.

The hyperstereoscopy may be minimized by complying with the physiological magnitudes and by imposing a gap between the neighbouring sensors of the inter-pupillary distance. This solution gives rise to excessive constraints for the integration of cameras or night sensors.

There exist digital processing operations allowing the reconstruction of 3D scenes on the basis of a stereoscopic camera or of a conventional camera in motion in a scene. Mention will be made, in particular, of application W02009-118156 entitled “Method for generating a 3D-image of a scene from a 2D-image of the scene” which describes this type of processing. However, these processing operations are performed in non-real time, by post-processing and are too unwieldy to embed for real-time operation as demanded by helmet viewing systems.

### SUMMARY OF THE INVENTION

The method for correcting hyperstereoscopy according to the invention consists in reconstructing the right and left images so as to obtain the picture shots equivalent to natural stereoscopy without having to position oneself at the natural physiological separation of 65 mm.

More precisely, the subject of the invention is a method for correcting hyperstereoscopy in a helmet viewing device worn by a pilot, the said pilot placed in an aircraft cockpit, the viewing device comprising: a first binocular assembly of image sensors able to operate at low light level and delivering a first intensified image termed the left image and a second intensified image termed the right image of the exterior landscape, the optical axes of the two sensors being separated by a distance termed the hyperstereoscopic distance; a second binocular helmet viewing assembly comprising two helmet displays arranged so as to present the first intensified image and the second intensified image to the pilot, the optical axes of the two displays being separated by the inter-pupillary distance; and a graphical calculator for processing images. It is characterized in that the method for correcting hyperstereoscopy is carried out by the graphical calculator and comprises the following steps: Step 1: Decomposition of the first and of the second intensified image into multiple distinct elements recognizable as identical in the two images; Step 2: Calculation for each element found of an associated distance from the pilot and of the displacement of the said element to be performed in each image so as to return to a natural stereoscopic position, that is to say corresponding to the inter-pupillary distance; Step 3: Reconstruction of a first and of a second processed image on the basis of the multiple displaced elements; Step 4: Presentation of the first processed reconstructed image and of the second processed reconstructed image in the second binocular helmet viewing assembly.

Advantageously, step 1 is carried out in part by means of a point-to-point mapping of the two intensified images making it possible to establish a map of the disparities between the two images.

Advantageously, step 1 is carried out by means of a technique of “Image Matching” or of “Local Matching”.

Advantageously, step 1 is carried out by comparing a succession of first intensified images with the same succession captured simultaneously of second intensified images.

Advantageously, step 1 is followed by a step 1 bis of cropping each element.

The invention also relates to the helmet viewing device implementing the above method, the said device comprising: a first binocular assembly of image sensors able to operate at low light level and delivering a first intensified image and a second intensified image, a second binocular helmet viewing assembly arranged so as to present the first intensified image and the second intensified image to the pilot; a graphical calculator for processing images; characterized in that the calculator comprises the electronic and computerized means arranged so as to implement the method for correcting hyperstereoscopy.

### BRIEF DESCRIPTION OF THE DRAWINGS

The invention will be better understood and other advantages will become apparent on reading the nonlimiting description which follows and by virtue of the appended figures among which:

FIG. 1 already described represents a helmet viewing device;

FIG. 2 represents the principle of the method of correction according to the invention;

FIG. 3 represents the intensified images seen by the two sensors before correction of the hyperstereoscopy;

FIG. 4 represents the same images after processing and correction of the hyperstereoscopy.

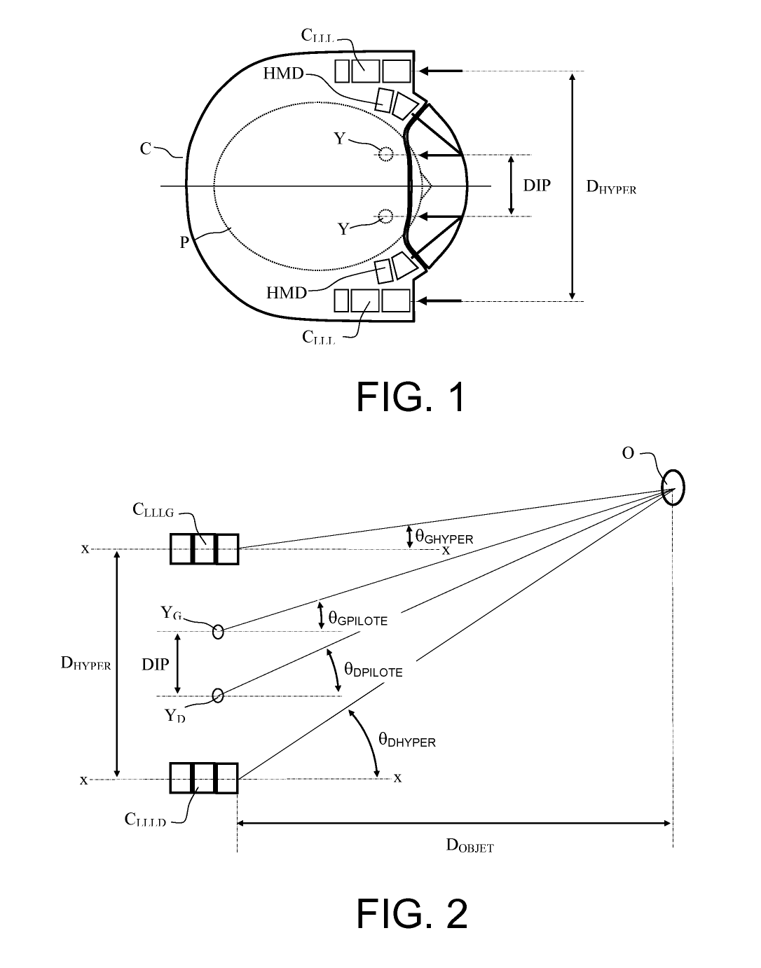

### DETAILED DESCRIPTION

The aim of the method according to the invention consists in obtaining natural stereoscopic vision on the basis of a binocular picture-capture system which is hyperstereoscopic by construction. This requires that the left and right images be recalculated on the basis of an analysis of the various elements making up the scene and of the evaluation of their distances. This also requires precise knowledge of the models of the system of sensors so as to facilitate the search for the elements and their registration.

The method for correcting hyperstereoscopy according to the invention therefore rests on two principles. On the one hand, it is possible to determine particular elements in an image and to displace them within this image and on the other hand, by virtue of the binocularity of the viewing system, it is possible to determine the distance separating the real elements from the viewing system.

More precisely, the method comprises the following four steps: Step 1: Decomposition of the first and of the second intensified image into multiple distinct elements recognizable as identical in the two images; Step 2: Calculation for each element found of an associated distance from the pilot and of the displacement of the said element to be performed in each image so as to return to a natural stereoscopic position, that is to say corresponding to the inter-pupillary distance; Step 3: Reconstruction of a first and of a second processed image on the basis of the multiple displaced elements; Step 4: Presentation of the first processed reconstructed image and of the second processed reconstructed image in the second binocular helmet viewing assembly.

These steps are detailed hereinbelow.

Step 1: Search for the elements

There currently exist numerous graphical processing operations making it possible to search for particular elements or objects in an image. Mention will be made, in particular, of disparity search or “matching” schemes. In the present case, these techniques are facilitated in so far as the images provided by the left and right sensors are necessarily very much alike. It is therefore necessary to identify substantially the same elements in each image. All the calculations which follow are performed without difficulty by a graphical calculator in real time.

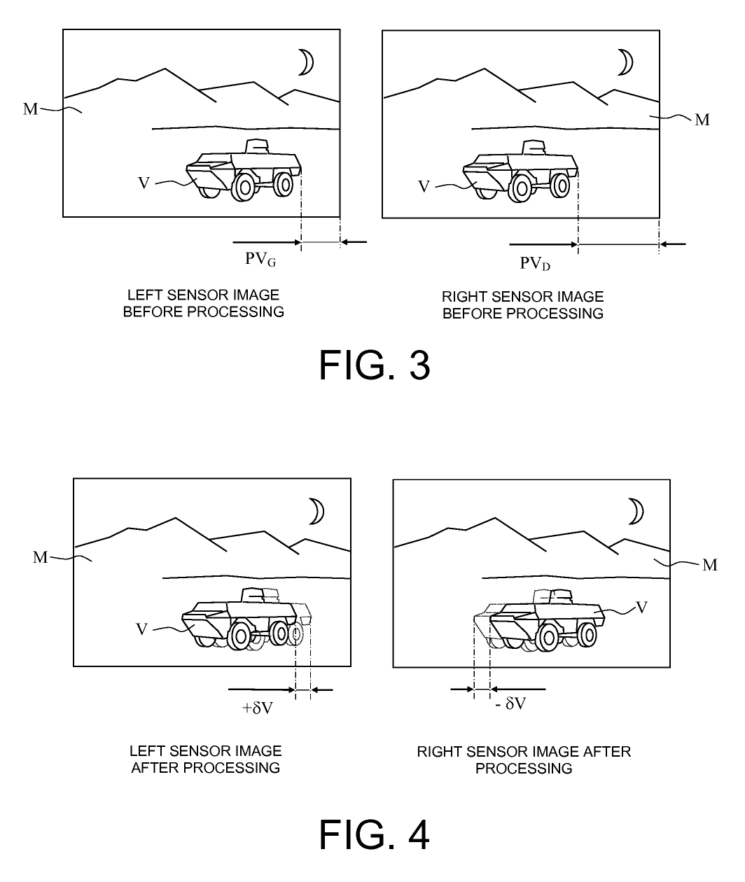

The disparity search scheme makes it possible to establish a mapping of the point-to-point or pixel-by-pixel differences corrected by the model of sensors of the binocular system. This model is defined, for example, by a mapping of the gains, by an offset, shifts of angular positioning, the distortion of the optics, etc. This mapping of the disparities makes it possible, by retaining the points whose difference of intensity or of level is greater than a predefined threshold, to simply identify the zones containing the “non-distant” elements of the scene also called the “Background”. This use is also beneficial in so-called “low-frequency” or LF mapping. By way of example, the two views of FIG. 3 represent a night scene viewed by left and right sensors. In these views, a mountain M landscape is found in the background and a vehicle V in the foreground. As seen in these views, the positions PV_{G} and PV_{D} of the vehicle V in the left and right images are different. This difference is related to the hyperstereoscopic effect.

Schemes for so-called “matching” on the identified zones are used either by correlating neighbourhoods or searching for and “matching” points of interest by using suitable descriptors, or by analysing scene contours and by “matching” contours. The latter scheme exhibits the benefit of simplifying the following step, the contours already being cropped. This analysis phase is simplified by the fixed direction of the motion to be identified, on the axis of the pupils of the sensors, giving a search axis for matching the points and zones.

It is also possible to carry out mappings of motion between the two sensors in so far as the aircraft is necessarily moving. A motion estimation of the “optical flow compensation” type is then carried out. This analysis is also simplified by the fixed direction of the motion to be identified, on the axis of the pupils of the sensors and of the eyes.

It is beneficial to perform a precise cropping of the elements found so as to better estimate their distances from the picture-capture sensors. This precise cropping serves moreover greatly in phase 3 of reconstructing the image so as to perform the most apt possible displacement of this element in the resulting images.

Step 2: Calculation of the distances and displacements

Once the various elements of the scene have been identified and matched pairwise between the images of the right and left sensors, the distance D associated with each of these elements can be estimated fairly finely by the lateral shift in terms of pixels in the two images and the model of the system of sensors. FIG. 2 illustrates the principle of calculation.

To simplify the demonstration, the calculation is done in a plane containing the axes xx of the sensors. The figure is effected at zero roll for the head of the pilot. In the case of roll, all the sensors together with the eyes tilt by the same angle and it is possible to revert, through a simple change of reference frame, to a configuration where the head is at zero roll and where the scene has rotated. Roll does not therefore affect the calculations.

This calculation is also done in the real space of the object. In this space, an object or an element O is viewed by the first, left, sensor C_{BNLG} at an angle θ_{GHYPER} and the same object O is viewed by the second, right, sensor C_{BNLD} at an angle θ_{DHYPER}. These angles are determined very easily by knowing the positions of the object O in the image and the focal lengths of the focusing optics disposed in front of the sensors. Knowing these two angles θ_{GHYPER}, θ_{DHYPER} and the distance D_{HYPER} separating the optical axes of the sensors, the distance D_{OBJET} of the object from the system is easily calculated through the simple equation:

D_{OBJET}=D_{HYPER}/(tgθ_{GHYPER}−tgθ_{DHYPER})

Knowing this distance D_{OBJET}, it is then easy to recalculate the angles at which this object would be viewed by the two eyes of the pilot, the eyes being separated by an inter-pupillary distance or DIP which generally equals around 65 millimetres. The angles θ_{DPILOTE} and θ_{GPILOTE} are obtained via the formulae:

tgθ_{GPILOTE}=tgθ_{GHYPER}+(D_{HYPER}−DIP)/2D_{OBJET}

tgθ_{DPILOTE}=tgθ_{DHYPER}−(D_{HYPER}−DIP)/2D_{OBJET}

The term (D_{HYPER}−DIP)/2D_{OBJET} corresponds to the angular displacements to be performed on the images of the object O in the left and right images so as to correspond to stereoscopic natural vision. These displacements are equal and oppositely directed. These angular values of the real space are easily converted into displacements of position of the object O in the left and right images.

Step 3: Reconstruction of the stereoscopic images

This reconstruction is done by calculation of the corrected right and left images. This calculation is based on the right and left images acquired with the hyperstereoscopy of the system, the elements recognized in its images and the calculated displacements to be performed on these elements. The reconstruction phase consists in removing the recognized elements of the scene and in repositioning them in accordance with the angular shift calculated by inlaying. The two, left and right, images make it possible to retrieve the contents of the image that are masked by the object present in each image. The left image memory allows the reconstruction of the information missing from the right image and vice versa. By way of simple example, FIG. 4 represents the corrected left and right images corresponding to those of FIG. 3. The vehicle V has been displaced by +δV in the left image and by −δV in the right image. The dotted parts represent the parts missing from the image and which have had to be appended.

In this phase, it is possible to correct the differences in projection by homomorphism. To carry out this step, it is beneficial to have a precise model of the characteristics of the sensors. Despite everything, zones which are not covered by the picture shots may persist. The latter may be filled with a neutral background corresponding to a mean grey on black and white images. Vision of these zones becomes monocular without observation being disturbed.

In the case of use for a helmet sight system where the sensors are integrated into the helmet, the system can advantageously make it possible to optimize the processing operations for image improvement and/or filtering.

The images thus reconstructed give natural vision whatever the separation between the two picture shots.

The quality of reconstruction depends greatly on the fineness of the cropping of the object. The residual artefacts are subdued through difference compensation or spatial averaging during merging of the two image zones.

The parallelization of the calculations performed by the graphical calculator on the left and right images and the organization of the image memory by shared access makes it possible to optimize the calculation time. All the processing operations are done in real time to allow display of a corrected video stream without latency, that is to say with a display delay of less than the display time of a frame. This time is, for example, 20 ms for a frame display frequency of 50 hertz.

Step 4: Presentation of the stereoscopic images

The images thus reconstructed are thereafter displayed in the helmet displays. It is, of course, possible to incorporate into the reconstructed images a synthetic image affording, for example, information about piloting or other systems of the aircraft. This image may or may not be stereoscopic, that is to say be identical on the two helmet displays, left and right, or different so as to be viewed at finite distance.

1. A method for correcting hyperstereoscopy in a helmet viewing device worn by a pilot, said pilot placed in an aircraft cockpit, the viewing device comprising a first binocular assembly of image sensors able to operate at low light level and delivering a first intensified image and a second intensified image of the exterior landscape, the optical axes of the two sensors being separated by a distance termed the hyperstereoscopic distance; and a second binocular helmet viewing assembly comprising two helmet displays and arranged so as to present the first intensified image and the second intensified image to the pilot, the optical axes of the two displays being separated by the inter-pupillary distance; and a graphical calculator for processing images; the method for correcting hyperstereoscopy being carried out by the graphical calculator and comprising the following steps:
step 1) decomposition of the first and of the second intensified image into multiple distinct elements recognizable as identical in the two images;
step 2) calculation for each element found of an associated distance from the pilot and of the displacement of the said element to be performed in each image so as to return to a natural stereoscopic position, that is to say corresponding to the inter-pupillary distance;
step 3) reconstruction of a first and of a second processed image on the basis of the multiple displaced elements;
step 4) presentation of the first processed reconstructed image and of the second processed reconstructed image in the second binocular helmet viewing assembly.

2. A method for correcting hyperstereoscopy according to claim 1, wherein step 1 is carried out in part by means of a point-to-point mapping of the two intensified images making it possible to establish a map of the disparities between the two images.

3. A method for correcting hyperstereoscopy according to claim 1, wherein step 1 is carried out by means of a technique of “Image Matching” or of “Local Matching”.

4. A method for correcting hyperstereoscopy according to claim 1, wherein step 1 is carried out by comparing a succession of first intensified images with the same succession captured simultaneously of second intensified images.

5. A method for correcting hyperstereoscopy according to claim 1, wherein step 1 is followed by a step 1bis of cropping each element.

6. A helmet viewing device comprising:
a first binocular assembly of image sensors able to operate at low light level and delivering a first intensified image and a second intensified image,
a second binocular helmet viewing assembly arranged so as to present the first intensified image and the second intensified image to the pilot; and
a graphical calculator for processing images;
wherein the calculator comprises the electronic and computerized means arranged so as to implement the method for correcting hyperstereoscopy according to claim 1.

7. A helmet viewing device comprising:
a first binocular assembly of image sensors able to operate at low light level and delivering a first intensified image and a second intensified image,
a second binocular helmet viewing assembly arranged so as to present the first intensified image and the second intensified image to the pilot; and
a graphical calculator for processing images;
wherein the calculator comprises the electronic and computerized means arranged so as to implement the method for correcting hyperstereoscopy according to claim 2.

8. A helmet viewing device comprising:
a first binocular assembly of image sensors able to operate at low light level and delivering a first intensified image and a second intensified image,
a second binocular helmet viewing assembly arranged so as to present the first intensified image and the second intensified image to the pilot; and
a graphical calculator for processing images;
wherein the calculator comprises the electronic and computerized means arranged so as to implement the method for correcting hyperstereoscopy according to claim 3.

9. A helmet viewing device comprising:
a first binocular assembly of image sensors able to operate at low light level and delivering a first intensified image and a second intensified image,
a second binocular helmet viewing assembly arranged so as to present the first intensified image and the second intensified image to the pilot; and
a graphical calculator for processing images;
wherein the calculator comprises the electronic and computerized means arranged so as to implement the method for correcting hyperstereoscopy according to claim 4.

10. A helmet viewing device comprising:
a first binocular assembly of image sensors able to operate at low light level and delivering a first intensified image and a second intensified image,
a second binocular helmet viewing assembly arranged so as to present the first intensified image and the second intensified image to the pilot; and
a graphical calculator for processing images;
wherein the calculator comprises the electronic and computerized means arranged so as to implement the method for correcting hyperstereoscopy according to claim 5.
